(19) United States
(12) Patent Application Publication
(10) Pub. No.: US 2007/0126971 A1
(43) Pub. Date: Jun. 7, 2007

(54) Dual-display device with rigid-flex printed board having bonded connection means

(75) Inventor: Wen-Kai Lo, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,278

(22) Filed: Dec. 4, 2006

(30) Foreign Application Priority Data
Dec. 2, 2005 (TW) 94221003

(51) Int. Cl. G02F 1/1345

(52) U.S. Cl. 349/149

(57) ABSTRACT

An exemplary dual-display device (2), includes a main liquid crystal display (LCD) panel (21), a subsidiary LCD panel (22), and a rigid-flex printed board (24) interconnecting the main LCD panel and the subsidiary LCD panel. The rigid-flex printed board includes a printed circuit board (PCB) (241) on which the subsidiary LCD panel is mounted, a first flexible printed circuit board (FPC) (243) electrically connected to the main LCD panel, and connection means (25) interconnecting the first FPC and the subsidiary LCD panel, wherein an end of the connection means is bonded to the subsidiary LCD panel. The rigid-flex printed board is relatively simple, and the cost of the dual-display device can be reduced.

### FIELD OF THE INVENTION

The present invention relates to a dual-display device that can be used in products such as a portable telephone, an information terminal, or the like.

### GENERAL BACKGROUND

In current flat display technology, dual-display devices have been developed for displaying images and characters on two opposite sides of the device. Dual-display devices are used mainly for folding mobile phones. In general, a dual-display device includes a main display panel, a subsidiary display panel, and a backlight module shared by the two display panels. In small-size products such as folding mobile phones, the main display panel and the subsidiary display panel are typically liquid crystal display (LCD) panels. The dual-display device has the advantages of being thin and light and requiring relatively few components.

FIG. 5 is an isometric, pre-assembled view of a typical dual-display device used in a portable telephone. The dual-display device 1 includes a main LCD panel 11, a subsidiary LCD panel 12, a rigid-flex printed board 14 connected between the two panels 11, 12, and a backlight module 16. The rigid-flex printed board 14 includes a window (not visible) corresponding to the subsidiary LCD panel 12.

The main LCD panel 11 includes a first substrate 111, a second substrate 112 opposite to the first substrate 111, and a first liquid crystal layer (not visible) sandwiched between the two substrates 111, 112.

The subsidiary LCD panel 12 includes a third substrate 121, a fourth substrate 122, and a second liquid crystal layer (not visible) sandwiched between the two substrates 121, 122.

The rigid-flex printed board 14 includes a printed circuit board (PCB) (not labeled), a flexible printed circuit board (FPC) (not labeled), and a connector 144. The window is defined in the PCB. One end of the FPC is connected to the PCB by a hot-press bonding method. The other end of the FPC is connected to the second substrate 112 of the main LCD panel 11 by a hot-press bonding method. The fourth substrate 122 of the subsidiary LCD panel 12 is connected to the PCB via an additional FPC 15 and the connector 144.

When the dual-display device 1 is assembled into the portable telephone, the backlight module 16 is sandwiched between the main LCD panel 11 and the rigid-flex printed board 14. The subsidiary LCD panel 12 is positioned at an outer side of the rigid-flex printed board 14, and the window of the PCB of the rigid-flex printed board 14 is located adjacent the backlight module 16.

The rigid-flex printed board 14 includes the connector 144 for connecting with the subsidiary LCD panel 12 via the additional FPC 15. The connector 144 is another component of the rigid-flex printed board 14 that adds to the cost of the dual-display device 1.

What is needed, therefore, is a dual-display device that can overcome the above-described deficiency.

### SUMMARY

In one preferred embodiment, a dual-display device, includes a main LCD panel, a subsidiary LCD panel, and a rigid-flex printed board interconnecting the main LCD panel and the subsidiary LCD panel. The rigid-flex printed board includes a PCB on which the subsidiary LCD panel is mounted, an FPC electrically connected to the main LCD panel, and connection means interconnecting the first FPC and the subsidiary LCD panel, wherein an end of the connection means is bonded to the subsidiary LCD panel. The rigid-flex printed board is relatively simple, and the cost of the dual-display device can be reduced.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an isometric, pre-assembled view of a dual-display device according to a first embodiment of the present invention.

FIG. 2 is an isometric, pre-assembled view of a dual-display device according to a second embodiment of the present invention.

FIG. 3 is an exploded, isometric view of a dual-display device according to a third embodiment of the present invention.

FIG. 4 is a partly assembled view of the dual-display device of FIG. 3.

FIG. 5 is an isometric, pre-assembled view of a conventional dual-display device used in a portable telephone.

### DETAILED DESCRIPTION OF PREFERRED EMBODIMENTS

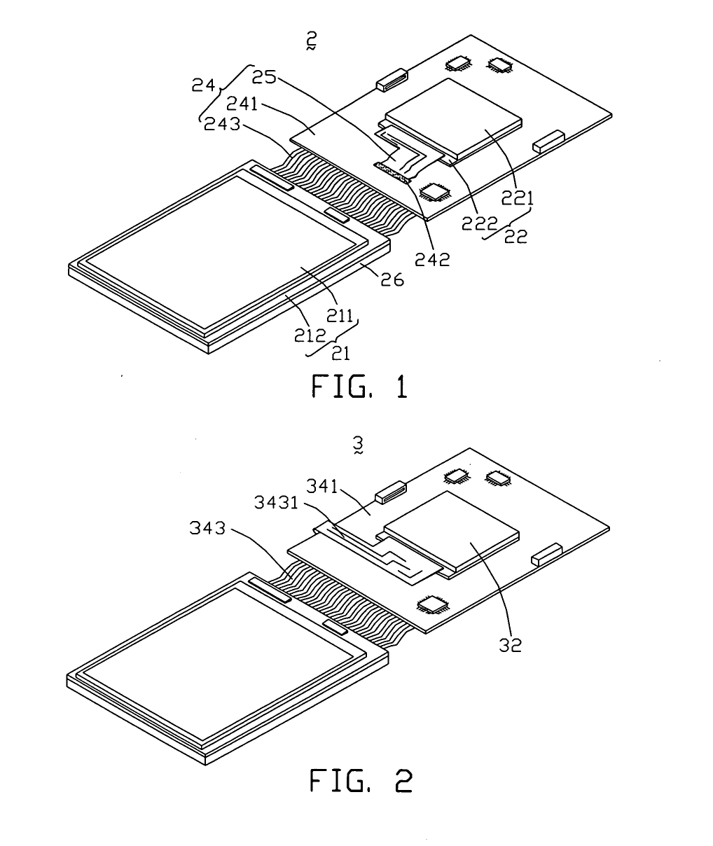

FIG. 1 is an isometric, pre-assembled view of a dual-display device 2 according to a first embodiment of the present invention. The dual-display device 2 includes a main LCD panel 21, a subsidiary LCD panel 22, a rigid-flex printed board 24 connected between the two panels 21, 22, and a backlight module 26. The rigid-flex printed board 24 includes a window (not visible) corresponding to the subsidiary LCD panel 22.

The main LCD panel 21 includes a first substrate 211, a second substrate 212 opposite to the first substrate 211, and a first liquid crystal layer (not visible) sandwiched between the two substrates 211, 212.

The subsidiary LCD panel includes a third substrate 221, a fourth substrate 222, and a second liquid crystal layer (not visible) sandwiched between the two substrates 221, 222.

The rigid-flex printed board 24 includes a PCB 241, a first FPC 243, and a second FPC 25. The window is defined in the PCB 241. One end of the first FPC 243 is connected to the PCB 241 by a hot-press bonding method. The other end of the first FPC 243 is connected to the second substrate 212 of the main LCD panel 21 by a hot-press bonding method. One end of the second FPC 25 is connected to the fourth substrate 222 of the subsidiary LCD panel 22 by a hot-press bonding method. The other end of the second FPC 25 is connected to the PCB 241 at a bonding area 242 of the PCB 241 by a hot-press bonding method.

When the dual-display device 2 is assembled into an apparatus such as a portable telephone (not shown), the backlight module 26 is sandwiched between the main LCD panel 21 and the rigid-flex printed board 24. The subsidiary LCD panel 22 is positioned at an outer side of the rigid-flex printed board 24, and the window of the PCB 241 is located adjacent the backlight module 26.

Because the second FPC 25 is directly connected to the PCB 241 of the rigid-flex printed board 24 at the bonding area 242, the rigid-flex printed board 24 does not need a connector for connecting with the subsidiary LCD panel 22. Thus, the cost of the dual-display device 2 is reduced.

FIG. 2 is an isometric, pre-assembled view of a dual-display device 3 according to a second embodiment of the present invention. The dual-display device 3 is similar to the dual-display device 2. However, an FPC 343 includes an end portion 3431 that extends from a main portion of the FPC 343. The end portion 3431 is folded over from a lateral side of a PCB 341 so that a main part of the end portion 3431 overlies an inner face of the PCB 341. A distal end of the end portion 3431 is connected to one of two substrates (not labeled) of a subsidiary LCD panel 32 by a hot-press bonding method.

Because the FPC 343 includes the end portion 3431 that is directly connected to the substrate of the subsidiary LCD panel 32, the rigid-flex printed board (not labeled) does not need an additional FPC and a connector for connecting with the subsidiary LCD panel 32. Thus, the cost of the dual-display device 3 is reduced.

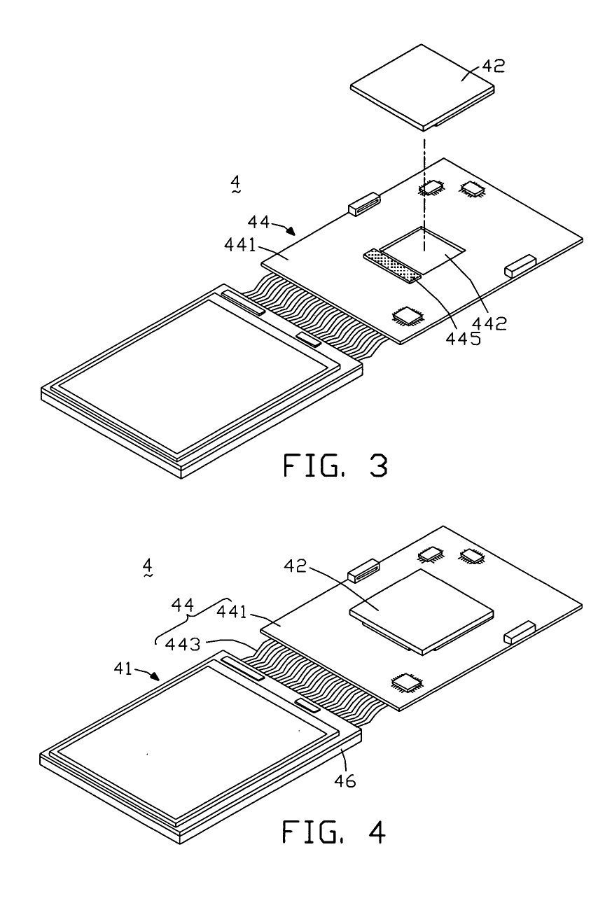

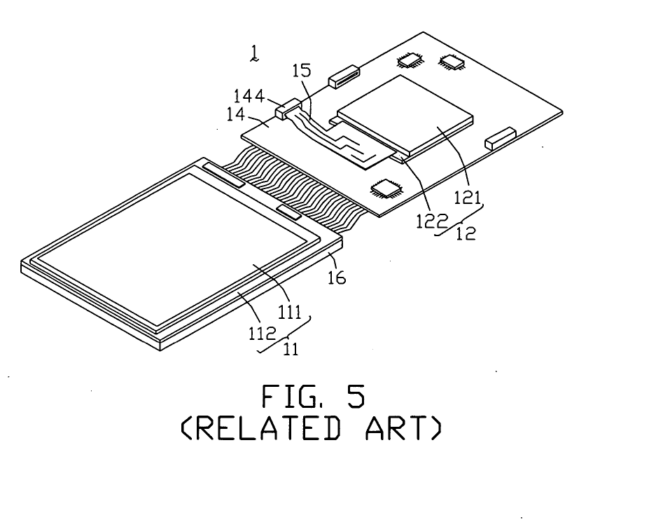

FIGS. 3 and 4 are isometric views of a dual-display device 4 according to a third embodiment of the present invention. The dual-display device 4 includes a main LCD panel 41, a subsidiary LCD panel 42, a rigid-flex printed board 44 interconnecting the two panels 41, 42, and a backlight module 46.

The rigid-flex printed board 44 includes a PCB 441 and an FPC 443. The PCB 441 includes a window 442 corresponding to the subsidiary LCD panel 42, and a bonding area 445 at a side of the window 442. In the illustrated embodiment, the window 442 is a square opening at a center of the PCB 441.

One end of the FPC 443 is connected to the PCB 441 by a hot-press bonding method. The other end of the FPC 443 is connected to the main LCD panel 41 by a hot-press bonding method. The subsidiary LCD panel 42 is directly connected to the bonding area 445 of the PCB 441 by a hot-press bonding method, and covers the window 442.

When the dual-display device 4 is assembled into an apparatus such as a portable telephone (not shown), the backlight module 46 is sandwiched between the main LCD panel 41 and the rigid-flex printed board 44. The subsidiary LCD panel 42 is positioned at an outer side of the rigid-flex printed board 44, and the window 442 of the PCB 441 is located adjacent the backlight module 46.

Because the subsidiary LCD panel 42 is directly connected to the bonding area 445 of the PCB 441, the rigid-flex printed board 44 does not need an additional FPC and a connector for connecting with the subsidiary LCD panel 42. Thus, the cost of the dual-display device 4 is reduced.

It is to be understood, however, that even though numerous characteristics and advantages of the present embodiments have been set out in the foregoing description, together with details of the structures and functions of the embodiments, the disclosure is illustrative only, and changes may be made in detail, including in matters of shape, size, and arrangement of parts within the principles of the invention to the full extent indicated by the broad general meaning of the terms in which the appended claims are expressed.

What is claimed is:

1. A dual-display device, comprising:
a main liquid crystal display (LCD) panel;
a subsidiary LCD panel; and
a rigid-flex printed board electrically interconnecting the main LCD panel and the subsidiary LCD panel, the rigid-flex printed board comprising a printed circuit board (PCB) on which the subsidiary LCD panel is mounted, a first flexible printed circuit board (FPC) electrically connected to the main LCD panel, and connection means interconnecting the first FPC and the subsidiary LCD panel, wherein an end of the connection means is bonded to the subsidiary LCD panel.

2. The display device as claimed in claim 1, wherein the connection means comprises a second FPC, an end of the second FPC is bonded to the subsidiary LCD panel, and an opposite end of the second FPC is bonded to the PCB.

3. The display device as claimed in claim 1, wherein the connection means is comprised in an end portion of the first FPC, and a distal end of the end portion of the first FPC is bonded to subsidiary LCD panel.

4. The display device as claimed in claim 1, wherein the PCB comprises a window corresponding to the subsidiary LCD panel.

5. The display device as claimed in claim 4, wherein the window is a square opening at a center of the PCB.

6. The display device as claimed in claim 5, wherein the connection means comprises a bonding area on the PCB adjacent the window, and the subsidiary LCD panel is bonded to the bonding area.

7. The display device as claimed in claim 1, wherein the end of the connection means is bonded to the subsidiary LCD panel by a hot-press bonding method.

8. The display device as claimed in claim 1, further comprising a backlight module positioned between the main LCD panel and the subsidiary LCD panel.

9. A dual-display device, comprising:
a main liquid crystal display (LCD) panel;
a subsidiary LCD panel; and
a rigid-flex printed board electrically interconnecting the main LCD panel and the subsidiary LCD panel, the rigid-flex printed board comprising a printed circuit board (PCB) on which the subsidiary LCD panel is mounted, and a flexible printed circuit board (FPC) electrically connected to the main LCD panel, wherein the first FPC comprises an end portion that is folded over from a lateral side of the PCB, and a distal end of the end portion is bonded to the subsidiary LCD panel.

10. The display device as claimed in claim 9, wherein the PCB comprises a window corresponding to the subsidiary LCD panel.

11. The display device as claimed in claim 10, wherein the window is a square opening at a center of the PCB.

12. The display device as claimed in claim 9, wherein the end portion of the FPC is bonded to the subsidiary LCD panel by a hot-press bonding method.

13. The display device as claimed in claim 9, further comprising a backlight module positioned between the main LCD panel and the subsidiary LCD panel.

14. A dual-display device, comprising:
a main liquid crystal display (LCD) panel;
a subsidiary LCD panel; and
a rigid-flex printed board electrically interconnecting the main LCD panel and the subsidiary LCD panel, the rigid-flex printed board comprising a printed circuit board (PCB) on which the subsidiary LCD panel is mounted, and a first flexible printed circuit board (FPC) electrically connected to the main LCD panel, wherein the PCB comprises a bonding area, and the subsidiary LCD panel is bonded to the bonding area.

15. The display device as claimed in claim 14, wherein the PCB comprises a window corresponding to the subsidiary LCD panel.

16. The display device as claimed in claim 15, wherein the window is a square opening at a center of the PCB.

17. The display device as claimed in claim 14, wherein the subsidiary LCD panel is bonded to the bonding area of the PCB by a hot-press bonding method.

18. The display device as claimed in claim 14, further comprising a backlight module positioned between the main LCD panel and the subsidiary LCD panel.
